(19) United States
(12) Patent Application Publication
(10) Pub. No.: US 2021/0309879 A1
(43) Pub. Date: Oct. 7, 2021

(54) FLUID SETS

(71) Applicant: Hewlett-Packard Development Company, L.P., Spring, TX (US)

(72) Inventors: Dennis Z. GUO, San Diego, CA (US); Jie ZHENG, San Diego, CA (US)

(73) Assignee: Hewlett-Packard Development Company, L.P., Spring, TX (US)

(21) Appl. No.: 17/267,136

(22) PCT Filed: Dec. 17, 2018
(86) PCT No.: PCT/US2018/065979

§ 371 Date: Feb. 9, 2021

(51) Int. Cl. C09D 11/54; C09D 11/40; C09D 11/38; C09D 11/322; C09D 11/102; C09D 11/037; B41M 5/00; D06P 5/30; D06P 5/00; D06P 1/52

(52) U.S. Cl. CPC C09D 11/54; C09D 11/40; C09D 11/38; C09D 11/322; C09D 11/102; C09D 11/037; D06P 3/60; B41M 5/0047; B41M 5/0064; B41M 5/0017; D06P 5/30; D06P 5/002; D06P 1/5285; B41M 5/0023

(57) ABSTRACT

A fluid set can include an ink composition and a fixer composition. The ink composition can include an ink vehicle, pigment, and from 2 wt % to 15 wt % polyurethane binder The fixer composition can include a fixer vehicle, from 1 wt % to 10 wt % quaternary amine-containing polymer, and from 0.5 wt % to 8 wt % blocked nonionic polyisocyanate crosslinking agent.

### BACKGROUND

Inkjet printing has become a popular way of recording images on various media. Some of the reasons include low printer noise, variable content recording, capability of high speed recording, and multi-color recording. These advantages can be obtained at a relatively low price to consumers. As the popularity of inkjet printing increases, the types of use also increase providing demand for new ink compositions. In one example, textile printing can have various applications including the creation of signs, banners, artwork, apparel, wall coverings, window coverings, upholstery, pillows, blankets, flags, tote bags, clothing, etc.

### BRIEF DESCRIPTION OF THE DRAWINGS

FIG. 1 schematically represents an example fluid set, including an ink composition and a fixer fluid, in accordance with the present disclosure;

FIG. 2 schematically depicts an example textile printing system that includes an ink composition, a fixer fluid, and a print media substrate, in accordance with the present disclosure; and

FIG. 3 depicts an example method of printing in accordance with the present disclosure.

### DETAILED DESCRIPTION

Textile printing has various applications and can provide the print media with various natural fabric textures. In accordance with the present disclosure, one example of a fluid set includes an ink composition including an ink vehicle, pigment, and from 2 wt % to 15 wt % polyurethane binder. The ink composition also includes a fixer composition including a fixer vehicle, from 1 wt % to 10 wt % quaternary amine-containing polymer, and from 0.5 wt % to 8 wt % blocked nonionic polyisocyanate crosslinking agent. In one example, the quaternary amine-containing polymer has a weight average molecular weight of from 3,000 Mw to 200,000 Mw. In an additional example, the quaternary amine-containing polymer includes a dimethylamine-epichlorohydrin copolymer having the structure of Formula I:

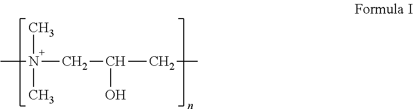

where n is from 22 to 1,500. In yet other examples, the quaternary amine-containing polymer includes polydiallyldimethylammonium chloride (polyDADMAC) having the structure of Formula II:

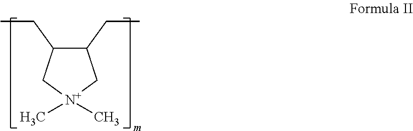

where m is from 18 to 1,250. In yet other examples, the blocked nonionic polyisocyanate crosslinker includes a blocked nonionic isocyanate trimer having the structure of Formula III, as follows:

(NCO)₃R₃(NHCO)₃(BL)_{3-X}(DL)_{X} Formula III

where individual R groups independently includes a C2 to C10 branched or straight-chained alkyl, C6 to C20 alicyclic, C6 to C20 aromatic, or a combination thereof; BL includes a phenol blocking group, a lactam blocking group, an oxime blocking group, a pyrazole blocking group, or a combination thereof; x is from 0 to 1; and DL includes a hydrophilic dispersing group. In another example, the pigment is a white pigment selected from titanium dioxide, talc, zinc oxide, zinc sulfide, lithopone, or a combination thereof. In still additional examples, the fixer vehicle includes water and an organic co-solvent, the water being present in the fixer composition in an amount of from 60 wt % to 95 wt %, and the organic co-solvent being present in the fixer composition in an amount of from 1.5 wt % to 38.5 wt %.

In another example, a textile printing system includes a fabric substrate, an ink composition, and a fixer composition. The ink composition includes an ink vehicle, pigment, and from 2 wt % to 15 wt % polyurethane binder. The fixer composition includes a fixer vehicle, from 1 wt % to 10 wt % quaternary amine-containing polymer, and from 0.5 wt % to 8 wt % blocked nonionic polyisocyanate crosslinking agent. In one example, the fabric substrate includes cotton, polyester, nylon, silk, or a blend thereof. In another example, the blocked nonionic polyisocyanate crosslinker includes a blocked nonionic isocyanate trimer. In an additional example, the quaternary amine-containing polymer includes dimethylamine-epichlorohydrin copolymer having the structure of Formula II:

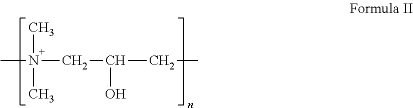

where n is from 22 to 1,500, or polydiallyldimethylammonium chloride (polyDADMAC) having the structure of Formula III:

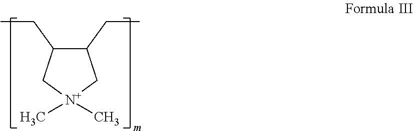

where m is from 18 to 1,250, or a combination thereof.

In another example, a method of textile printing includes jetting a fixer composition onto a fabric substrate, the fixer composition including from 1 wt % to 10 wt % quaternary amine-containing polymer, from 0.5 wt % to 8 wt % blocked nonionic polyisocyanate crosslinking agent, and a fixer vehicle. The method further includes jetting an ink composition onto the fabric substrate, the ink composition including pigment, from 2 wt % to 15 wt % polyurethane binder, and an ink vehicle. Additionally, the method incudes deblocking the blocked polyisocyanate crosslinker to crosslink the polyurethane binder with a deblocked polyisocyanate crosslinker in contact on the fabric substrate. In one example, jetting the fixer composition is performed prior to jetting the ink composition. In another example, deblocking the blocked polyisocyanate crosslinker occurs in response to applying heat to the blocked nonionic polyisocyanate crosslinker on the fabric substrate. In still additional examples, applying heat is at a temperature of from 80° C. to 200° C. for a period of from 5 seconds to 10 minutes.

In addition to the examples described above, the fluid sets, textile printing systems, and methods of textile printing will be described in greater detail below. It is also noted that when discussing the fluid sets, textile printing systems and methods of textile printing described herein, these relative discussions can be considered applicable to the other examples, whether or not they are explicitly discussed in the context of that example. Thus, for example, in discussing a fixer composition related to a fluid set, such disclosure is also relevant to and directly supported in the context of the textile printing systems and the methods of textile printing described herein, and vice versa.

Turning now to FIG. 1, an ink composition 100 can include an ink vehicle 102 (which can include water and organic co-solvent, for example) and pigment 104 (or pigment particles or solids) dispersed therein. A polyurethane polymer 108 can also be present. In this FIG., the relative sizes of the pigment and the polyurethane polymer are not necessarily drawn to scale. Furthermore, the pigment can further include a dispersing agent or dispersing polymer associated with a surface thereof, e.g., covalently attached as a part of a self-dispersed pigment, or ionically attracted to adsorbed onto the pigment surface, etc.

The pigment 104 can be any of a number of pigment colorant of any of a number of primary or secondary colors, or can be black or white, for example. More specifically, if a color, the color may include cyan, magenta, yellow, red, blue, violet, orange, green, etc. In one example, the ink composition 100 can be a black ink with a carbon black pigment. In another example, the ink composition can be a cyan or green ink with a copper phthalocyanine pigment, e.g., Pigment Blue 15:0, Pigment Blue 15:1; Pigment Blue 15:3, Pigment Blue 15:4, Pigment Green 7, Pigment Green 36, etc. In another example, the ink composition can be a magenta ink with a quinacridone pigment or a co-crystal of quinacridone pigments. Example quinacridone pigments that can be utilized can include PR122, PR192, PR202, PR206, PR207, PR209, PO48, PO49, PV19, PV42, or the like. These pigments tend to be magenta, red, orange, violet, or other similar colors. In one example, the quinacridone pigment can be PR122, PR202, PV19, or a combination thereof. In another example, the ink composition can be a yellow ink with an azo pigment, e.g., Pigment Yellow 74 and Pigment Yellow 155. In one example, the pigment can include aromatic moieties. In yet another example, the ink composition can be a white ink with a white pigment, e.g. titanium dioxide, talc, zinc oxide, zinc sulfide, lithopone, etc.

With respect to the dispersing agent or dispersing polymer mentioned previously, in some examples, the pigment 104 can be dispersed by a polymer dispersant, such as a styrene (meth)acrylate dispersant, or another dispersant suitable for keeping the pigment suspended in the liquid vehicle 102. For example, the dispersant can be any dispersing (meth)acrylate polymer, or other type of polymer, such as a styrene maleic acid copolymer. In one specific example, the (meth)acrylate polymer can be a styrene-acrylic type dispersant polymer, as it can promote π-stacking between the aromatic ring of the dispersant and various types of pigments, such as copper phthalocyanine pigments, for example. Examples of commercially available styrene-acrylic dispersants can include Joncryl® 671, Joncryl® 71, Joncryl® 96, Joncryl® 680, Joncryl® 683, Joncryl® 678, Joncryl® 690, Joncryl® 296, Joncryl 671, Joncryl 696 or Joncryl® ECO 675 (all available from BASF Corp., Germany).

The term “(meth)acrylate” or “(meth)acrylic acid” or the like refers to monomers, copolymerized monomers, etc., that can either be acrylate or methacrylate (or a combination of both), or acrylic acid or methacrylic acid (or a combination of both). This can be the case for either dispersant polymer for pigment dispersion or for dispersed polymer binder that may include co-polymerized acrylate and/or methacrylate monomers. Also, in some examples, the terms “(meth)acrylate” and “(meth)acrylic acid” can be used interchangeably, as acrylates and methacrylates described herein include salts of acrylic acid and methacrylic acid, respectively. Thus, mention of one compound over another can be a function of pH. Furthermore, even if the monomer used to form the polymer was in the form of a (meth)acrylic acid during preparation, pH modifications during preparation or subsequently when added to an ink composition can impact the nature of the moiety as well (acid form vs. salt form). Thus, a monomer or a moiety of a polymer described as (meth)acrylic acid or as (meth)acrylate should not be read so rigidly as to not consider relative pH levels, and other general organic chemistry concepts.

In further detail, the ink compositions 100 can also include a polyurethane binder 108. A variety of polyurethane binders can be used. In one example, the polyurethane binder is a polyester-polyurethane binder. In some further examples, the polyurethane binder can be a sulfonated polyester-polyurethane. In one example, the sulfonated polyester-polyurethane binder can be anionic. In further detail, the sulfonated polyester-polyurethane binder can also be aliphatic including saturated carbon chains therein as part of the polymer backbone or side-chain thereof, e.g., C2 to C10, C3 to C8, or C3 to C6 alkyl. These polyester-polyurethane binders can be described as “alkyl” or “aliphatic” because these carbon chains are saturated and because they are devoid of aromatic moieties. An example anionic aliphatic polyester-polyurethane binder that can be used is Impranil® DLN-SD (Mw 133,000 Mw; Acid Number 5.2; Tg −47° C.; Melting Point 175-200° C.) from Covestro (Germany). Example components used to prepare the Impranil® DLN-SD or other similar anionic aliphatic polyester-polyurethane binders can include pentyl glycols, e.g., neopentyl glycol; C4-C10 alkyldiol, e.g., hexane-1,6-diol; C4 to C10 alkyl dicarboxylic acids, e.g., adipic acid; C4 to C10 alkyl diisocyanates, e.g., hexamethylene diisocyanate (HDI); diamine sulfonic acids, e.g., 2-[(2-aminoethyl)amino]-ethanesulfonic acid; etc. Alternatively, the polyester-polyurethane binder can be aromatic (or include an aromatic moiety) along with aliphatic chains. An example of an aromatic polyester-polyurethane binder that can be used is Dispercoll® U42. Example components used to prepare the Dispercoll® U42 or other similar aromatic polyester-polyurethane binders can include aromatic dicarboxylic acids, e.g., phthalic acid; C4 to C10 alkyl dialcohols, e.g., hexane-1,6-diol; C4 to C10 alkyl diisocyanates, e.g., hexamethylene diisocyanate (HDI); diamine sulfonic acids, e.g., 2-[(2-aminoethyl)amino]-ethanesulfonic acid; etc. Other types of polyester-polyurethanes can also be used, including Impranil® DL 1380, which can be somewhat more difficult to jet from thermal inkjet printheads compared to Impranil® DLN-SD and Dispercoll® U42, but still can be acceptably jetted in some examples, and can also provide acceptable washfastness results on a variety of fabric types. Conversely, other types of polyurethanes (other than the polyester-type polyurethanes) do not tend to perform as well when jetting from thermal inkjet printheads and/or do not perform as well on fabric substrates, e.g., some jet acceptably but do not provide good washfastness, others provide good washfastness but are thermally jetted poorly, and others perform poorly in both categories. In still further detail, the pigmented ink compositions with polyester polyurethane binder can provide acceptable to good washfastness durability on a variety of substrates, making this a versatile ink composition for fabric printing, e.g., cotton, polyester, cotton/polyester blends, nylon, etc.

The polyurethane binder can typically be present in the ink composition in an amount from 2 wt % to 15 wt %. In other examples, the polyurethane binder can be present in the ink composition in an amount from 3 wt % to 11 wt %. In yet other examples, the polyurethane binder can be present in the ink composition in an amount from 4 wt % to 10 wt %. In still other examples, the polyurethane binder can be present in the ink composition in an amount from 5 wt % to 9 wt %.

Returning now to FIG. 1, the ink compositions 100 of the present disclosure can be formulated to include an ink vehicle 102, which can include the water content, e.g., 60 wt % to 90 wt % or from 75 wt % to 85 wt %, as well as organic co-solvent, e.g., from 4 wt % to 30 wt %, from 6 wt % to 20 wt %, or from 8 wt % to 15 wt %. Other liquid vehicle components can also be included, such as surfactant, antibacterial agent, other colorant, etc. However, as part of the ink composition, pigment, polymer dispersant, and the polyurethane polymer can be included or carried by the ink vehicle components.

In further detail regarding the ink vehicle 102, co-solvent(s) can be present and can include any co-solvent or combination of co-solvents that is compatible with the pigment, dispersant, polyurethane binder, etc. Examples of suitable classes of co-solvents include polar solvents, such as alcohols, amides, esters, ketones, lactones, and ethers. In additional detail, solvents that can be used can include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, e.g., Dowanol™ TPM (from Dow Chemical, USA), higher homologs (C₈-C₁₂) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, 2-ethyl-2-(hydroxymethyl)-1,3-propane diol (EPHD), glycerol, dimethyl sulfoxide, sulfolane, glycol ethers, alkyldiols such as 1,2-hexanediol and/or ethoxylated glycerols, such as LEG-1 (Liponic® EG-1, from Lipo Chemicals (USA)), etc.

The ink vehicle can also include surfactant. In general, the surfactant can be water soluble and may include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, and mixtures thereof. In some examples, the surfactant can include a nonionic surfactant, such as a Surfynol® surfactant, e.g., Surfynol® 440 (from Evonik, Germany), or a Tergitol™ surfactant, e.g., Tergitol™ TMN-6 (from Dow Chemical, USA). In another example, the surfactant can include an anionic surfactant, such as a phosphate ester of a C10 to C20 alcohol or a polyethylene glycol (3) oleyl mono/di phosphate, e.g., Crodafos® N3A (from Croda International PLC, United Kingdom). The surfactant or combinations of surfactants, if present, can be included in the ink composition at from 0.01 wt % to 5 wt % and, in some examples, can be present at from 0.05 wt % to 3 wt % of the ink compositions.

Consistent with the formulations of the present disclosure, various other additives may be included to provide desired properties of the ink composition for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, Acticide®, e.g., Acticide® B20 (Thor Specialties Inc.), Nuosept™ (Nudex, Inc.), Ucarcide™ (Union carbide Corp.), Vancide® (R.T. Vanderbilt Co.), Proxel™ (ICI America), and combinations thereof. Sequestering agents such as EDTA (ethylene diamine tetra acetic acid) may be included to eliminate the deleterious effects of heavy metal impurities, and buffer solutions may be used to control the pH of the ink. Viscosity modifiers and buffers may also be present, as well as other additives to modify properties of the ink as desired.

As also shown in FIG. 1, a fixer composition 110 is also shown, which can include a quaternary amine-containing polymer 114 and a blocked nonionic polyisocyanate crosslinking agent 116 in a fixer vehicle 112. Notably, the ink vehicle in the ink composition and the fixer vehicle in the fixer composition may or may not include the same liquid vehicle formulation, but in one example, they are not the same. Regardless, whether or not the ink vehicle and the fixer vehicle are the same, they can in some examples include common ingredients, such as water, for example, or other common organic co-solvents. Whether the same or different, both can also include an organic co-solvent. Thus, the discussion of the liquid vehicle described herein related to the ink composition is also relevant to the fixer vehicle of the fixer composition, and the same types of liquid vehicle components can be independently selected for use herein.

In some specific examples, the fixer vehicle can include from water and an organic co-solvent. Typically, water can be present in the fixer fluid in an amount from 60 wt % to 95 wt %. In other examples, water can be present in the fixer fluid in an amount from 70 wt % to 90 wt %. In still other examples, water can be present in the fixer fluid in an amount from 75 wt % to 85 wt %. Organic co-solvent can typically be present in the fixer fluid in an amount from 3.5 wt % to 38.5 wt %. In some examples, organic co-solvent can be present in the fixer fluid in an amount from 4 wt % to 25 wt %. In other examples, organic co-solvent can be present in the fixer fluid in an amount from 6 wt % to 20 wt %, or from 8 wt % to 18 wt %.

With specific reference to the quaternary amine-containing polymer 114 that is present in the fixer composition 110, FIG. 1 presents a representative simplified schematic formula for illustrative purposes only. The quaternary amine-containing polymer can act as a cationic fixing agent to improve the optical density, coalescence, bleed, durability of inks printed on fabric substrates, the like, or a combination thereof. A variety of quaternary amine-containing polymers, or combinations thereof, can be used. Generally, the quaternary amine-containing polymer can have a weight average molecular weight of from 3,000 Mw to 200,000 Mw. In some additional examples, the quaternary amine-containing polymer can have a weight average molecular weight of from 5,000 Mw to 50,000 Mw. It is also noted that the quaternary amine-containing polymer can be linear or branched. However, in some specific examples, the quaternary amine-containing polymer can be linear. In some additional specific examples, the quaternary amine-containing polymer can include a dimethylamine-epichlorohydrin copolymer having a structure of Formula II:

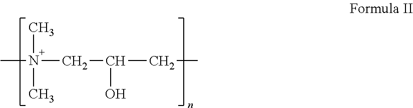

where n is from 22 to 1,500. In some other examples, n can be from 36 to 360. Additional examples of commercially available quaternary amine-containing polymers can include Floquat™ dimethylamine-epichlorohydrin copolymer commercially available from SNF Ltd. (United Kingdom), such as Floquat™ 2250, Floquat™ 2273, Floquat™ 2350, Floquat™ 2550, Floquat™ 2565, and Floquat™ 3050, or the like, for example. Yet in other examples, the quaternary amine-containing polymer can include polydiallyldimethylammonium chloride (polyDADMAC) having the structure of Formula III:

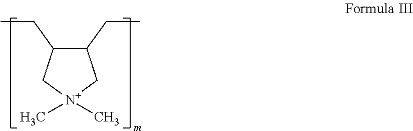

where m is from 18 to 1,250. Examples of commercially available polyDADMAC polymers can include Floquat™ 4340, Floquat™ 4440, Floquat™ 4450, Floquat™ 4420, Floquat™ 4520, Floquat™ 4530 and Floquat™ 4450 from SNF Ltd. (United Kingdom), or PAS-H-1L, PAS-H-5L and PAS-H-10L from Nittobo (Japan). In some examples, the quaternary amine-containing polymer can include a combination of dimethylamine-epichlorohydrin copolymer and polyDADMAC.

The quaternary amine-containing polymer can typically be present in the fixer composition in an amount from 1 wt % to 10 wt %. In other examples, the quaternary amine-containing polymer can be present in the fixer composition in an amount from 2 wt % to 6 wt %, or from 3 wt % to 5 wt %.

Turning now to blocked nonionic polyisocyanate 116 that can be present in the fixer composition 110, FIG. 1 presents a representative simplified schematic formula for illustrative purposes only. It is noted that while the quaternary amine-containing polymer described above can act as an effective fixing agent to improve optical density, in some examples the washfastness of the printed inks can be further improved by including a blocked nonionic polyisocyanate in the fixer composition. It is noted that blocked anionic polyisocyanates are not suitable in the present fixer compositions because they can precipitate upon mixing with the cationic quaternary amine-containing polymer also present in the fixer composition.

In further detail, the isocyanate groups of the blocked nonionic polyisocyanates can be reactive as crosslinkers when printed on the fabric substrate, but within the fixer composition, the isocyanate groups can remain stable due to the blocking group attached to the isocyanate(s). Thus, the term “blocked nonionic polyisocyanate” refers to compounds with multiple isocyanate groups where a plurality of the isocyanate groups are coupled to a chemical moiety that stabilize the isocyanate groups in the ink composition or crosslinker composition so that they remain available for reaction after printing on the fabric substrate. The chemical moiety that prevents the isocyanate groups from reacting can be referred to herein as a “blocking group.” To convert the blocked nonionic polyisocyanate to a reactive species, the blocking group can be dissociated from isocyanate groups to result in a “deblocked nonionic polyisocyanate.” Deblocking can occur in a variety of ways, such as by heating the blocked nonionic polyisocyanate to a temperature where deblocking or dissociation can occur, e.g., typically at from 80° C. to 200° C. There are deblocking or dissociation temperatures outside of this range, e.g., at lower temperatures, but in accordance with examples of the present disclosure, higher temperature can generally accelerate the deblocking, thus requiring less curing time.

A blocked nonionic polyisocyanate and the deblocking that can occur can be represented by example in Formulas II or III, as follows:

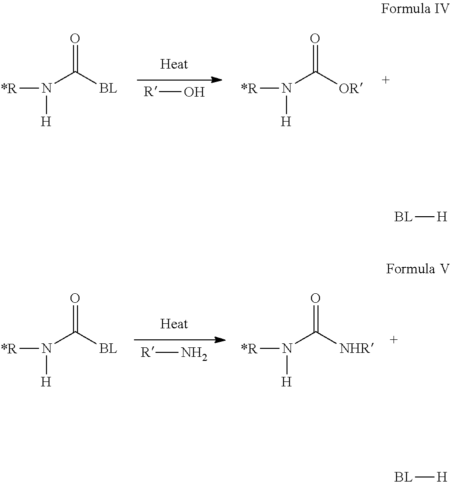

where in Formula IV and Formula V above, R can be a linking group that connects the blocked isocyanate group shown to any organic group that includes other blocked isocyanates (as the blocked isocyanates used in accordance with the present disclosure is a blocked “poly” isocyanates, meaning that the crosslinker composition includes more than one isocyanate group). For example, R can independently include a C2 to C10 branched or straight-chained alkyl, C6 to C20 alicyclic, C6 to C20 aromatic, or a combination thereof. The asterisk (*) denotes the organic group with additional blocked isocyanate groups that extend beyond the R linking group (see Formula VI below, for example, which includes the balance of a nonionic polyisocyanate trimer including two additional isocyanate groups). In further detail, R′ in Formula IV and Formula V can be any organic group that can be coupled to the hydroxyl or amine group to replace the blocking group (BL) of the isocyanate, typically liberating a hydrogen to associate with the blocking group, as shown. In one example, R′—OH or R′—NH₂ can be a residual group present in the polyurethane binder in the ink, and in other examples, the R′—OH group can be present in cotton and cotton blend fabric substrates. In further detail, regarding the dispersed polymer binder, the binder can be crosslinked when the blocked nonionic polyisocyanate is deblocked on the fabric substrate, such as with a fabric substrate including cotton fibers, or a blend of cotton and polyester fibers, for example.

An example blocked nonionic polyisocyanate that can be used is a blocked polyisocyanate trimer having the structure shown in Formula VI, as follows:

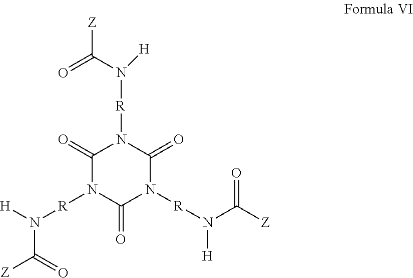

where R is independently a C2 to C10 branched or straight-chained alkyl, C6 to C20 alicyclic, C6 to C20 aromatic, or a combination thereof; and Z independently includes a blocking group (also referred to as “BL” or “BL groups”), a hydrophilic dispersing group (also referred to as “DL” or “DL groups”), or a combination of both. Typically, the three independent Z groups shown in Formula VI can represent from 2 to 3 blocking groups (BL) and from 0 to 1 nonionic hydrophilic dispersing groups (DL) per trimer molecule. Thus, in some examples, there may be no nonionic hydrophilic groups, and in other examples there may be from 0.1 to 1 nonionic hydrophilic groups. Examples of the nonionic hydrophilic dispersing groups (DL) can include polyether monoamine such as JEFFAMINE® monoamine products from Huntsman (USA) and methoxypolyethylene glycols such as CARBOWAX™ MPEGs from Dow Chemicals (USA). Example BL groups that can be present include a phenol blocking group, a lactam blocking group, an oxime blocking group, a pyrazole blocking group, or a combination thereof. The hydrophilic dispersing group can be a non-ionic hydrophilic group to assist with dispersing the blocked nonionic polyisocyanate in the fixer composition. Thus, with specific reference to Z in Formula VI, there may be some specific individual molecules with three BL groups, and other individual molecules within the fixer composition that include less than three BL groups. In further detail, Formula VI can be expressed to include the nonionic hydrophilic groups (DL) associated with the blocking groups (BL), shown previously in Formula VI, and shown again below in Formula I, as follows:

(NCO)₃R₃(NHCO)₃(BL)_{3-X}(DL)_{X} Formula I

where x is from 0 to 1; DL is a nonionic hydrophilic dispersing group that can assist with dispersing the blocked nonionic polyisocyanate in the fixer composition; and BL is a blocking group, such as a phenol blocking group, a lactam blocking group, an oxime blocking group, a pyrazole blocking group, or a combination thereof. Notably, group Z is not shown in Formula I, as Z represents a combination of both BL and DL (when present). In one example, the blocking group, once liberated (as BL-H) can be ε-caprolactam, butanone oxime, or 3,5-dimethyl pyrazole, for example. If DL is present, it can be present at from greater than 0 to 1, or from 0.1 to 1, or from 0.25 to 1, or from 0.5 to 1, or from 0.1 to 0.5, for example. Again, R can independently be a C2 to C10 branched or straight-chained alkyl, C6 to C20 alicyclic, C6 to C20 aromatic, or a combination thereof. In a still more specific example, x can be from greater than 0 to 1, BL can be a dimethylpyrazole, DL can be JEFFAMINE® M-1000, and R can be C4 to C8 alkyl or C8 to C14 methylated alicyclic group. In this example, because JEFFAMINE® M-1000 I is present, x is greater than 0, e.g., from 0.1 to 1. The concentration of DL present can depend on the concentration useful for suspending the blocked nonionic polyisocyanate in the fixer composition. In further detail, example R groups include those present to complete IPDI trimers, e.g., methylated alicyclic R groups (sometimes also referred to as cycloaliphatic groups) such as present in N,N′,N″-Tris(5-isocyanato-1,3,3-trimethylcyclohexylmethyl)-2,4,6-triketohexahydrotriazine; or a HDI trimers, e.g., where R may be C2 to C10 alkyl, C2 to C8 alkyl, C2 to C6 alkyl, C3 to C8 alkyl, C4 to C8 alkyl, or C4 to C10 alkyl, such as Desmodur® N3300 from Covestro Corporation (Germany).

Two non-limiting examples of blocked nonionic polyisocyanates that can be used include Matsui Fixer WF-N from Matsui Shikiso Chemical (Japan) and Trixene® Aqua BI from Baxenden (UK). These materials can be deblocked at about 150° C.

The blocked nonionic polyisocyanate can typically be present in the fixer composition in an amount from 0.5 wt % to 5 wt %. In other examples, the blocked nonionic polyisocyanate can be present in the fixer composition in an amount from 1 wt % to 4 wt %. In still other examples, the blocked nonionic polyisocyanate can be present in the fixer composition in an amount from 1.5 wt % to 3.5 wt %.

Thus, the quaternary amine-containing polymer can act as a cationic fixing agent to help fix the pigment from the ink composition to the fabric print media to improve optical density, coalescence, bleed, durability, the like, or a combination. The blocked nonionic polyisocyanate can be deblocked to crosslink with the polyurethane binder in the ink composition, the fabric print media, or a combination thereof to improve the washfastness of the printed ink composition, which in cases can be deteriorated with the quaternary amine-containing polymer alone. Thus, the combination of the quaternary amine-containing polymer and the blocked nonionic polyisocyanate can improve both optical density and washfastness as compared to printing without the fixing agent or printing with a fixer composition having only one of the quaternary amine-containing polymer or the blocked nonionic polyisocyanate.

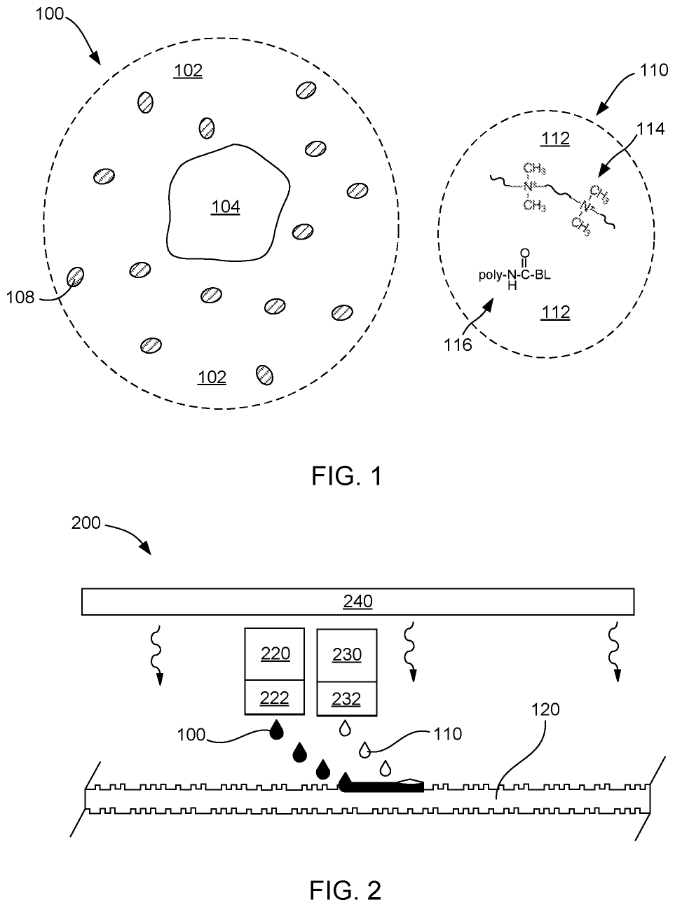

As shown in FIG. 2, a textile printing system 200 is shown schematically and can include an ink composition 100 and a fixer composition 110 for printing on a fabric substrate 120. In some examples, the textile printing system can further include various architectures related to ejecting fluids and treated fluids after ejecting onto the fabric substrate. For example, the ink composition can be printed from an inkjet pen 220 which includes an ejector 222, such as a thermal inkjet ejector or some other digital ejector technology. Likewise, the fixer fluid can be printed from a fluidjet pen 230 which includes an ejector 232, such as a thermal ejector or some other digital ejector technology. The inkjet pen and the fluidjet pen can be the same type of ejector, or can be two different types ejectors. Both may be thermal inkjet ejectors, for example. Also shown, as can be include in one example, is a heating device 240 to apply heat to the fabric substrate to cure the ink composition, e.g., causing the crosslinking reaction to occur or accelerate.

The ink compositions 100 and fixer compositions 110 may be suitable for printing on many types of fabric substrates 120, such as natural fabrics, synthetic fabrics, etc. Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources (e.g. cornstarch, tapioca products, sugarcanes), etc. Example synthetic fibers used in the fabric substrates can include polymeric fibers such as, nylon fibers, polyvinyl chloride (PVC) fibers, PVC-free fibers made of polyester, polyamide, polyimide, polyacrylic, polypropylene, polyethylene, polyurethane, polystyrene, polyaramid (e.g., Kevlar®) polytetrafluoroethylene (Teflon®) (both trademarks of E. I. du Pont de Nemours Company, Delaware), fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, a copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation.

The fabric substrate can be in one of many different forms, including, for example, a textile, a cloth, a fabric material, fabric clothing, or other fabric product suitable for applying ink, and the fabric substrate can have any of a number of fabric structures. The term “fabric structure” is intended to include structures that can have warp and weft, and/or can be woven, non-woven, knitted, tufted, crocheted, knotted, and pressured, for example. The terms “warp” and “weft” have their ordinary meaning in the textile arts, as used herein, e.g., warp refers to lengthwise or longitudinal yarns on a loom, while weft refers to crosswise or transverse yarns on a loom.

It is notable that the term “fabric substrate” or “fabric media substrate” does not include materials commonly known as any kind of paper (even though paper can include multiple types of natural and synthetic fibers or mixtures of both types of fibers). Fabric substrates can include textiles in filament form, textiles in the form of fabric material, or textiles in the form of fabric that has been crafted into a finished article (e.g. clothing, blankets, tablecloths, napkins, towels, bedding material, curtains, carpet, handbags, shoes, banners, signs, flags, etc.). In some examples, the fabric substrate can have a woven, knitted, non-woven, or tufted fabric structure. In one example, the fabric substrate can be a woven fabric where warp yarns and weft yarns can be mutually positioned at an angle of 90°. This woven fabric can include but is not limited to, fabric with a plain weave structure, fabric with twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of two or more of these processes.

As previously mentioned, the fabric substrate can be a combination of fiber types, e.g. a combination of any natural fiber with another natural fiber, any natural fiber with a synthetic fiber, a synthetic fiber with another synthetic fiber, or mixtures of multiple types of natural fibers and/or synthetic fibers in any of the above combinations. In some examples, the fabric substrate can include natural fiber and synthetic fiber. The amount of individual fiber types can vary. For example, the amount of the natural fiber can vary from 5 wt % to 95 wt % and the amount of synthetic fiber can range from 5 wt % to 95 wt %. In yet another example, the amount of the natural fiber can vary from 10 wt % to 80 wt % and the synthetic fiber can be present from 20 wt % to 90 wt %. In other examples, the amount of the natural fiber can be 10 wt % to 90 wt % and the amount of synthetic fiber can also be 10 wt % to 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa.

In one example, the fabric substrate can have a basis weight ranging from 10 gsm to 500 gsm. In another example, the fabric substrate can have a basis weight ranging from 50 gsm to 400 gsm. In other examples, the fabric substrate can have a basis weight ranging from 100 gsm to 300 gsm, from 75 gsm to 250 gsm, from 125 gsm to 300 gsm, or from 150 gsm to 350 gsm.

In addition, the fabric substrate can contain additives including, but not limited to, colorant (e.g., pigments, dyes, and tints), antistatic agents, brightening agents, nucleating agents, antioxidants, UV stabilizers, fillers and lubricants, for example. Alternatively, the fabric substrate may be pre-treated in a solution containing the substances listed above before applying other treatments or coating layers.

Regardless of the substrate, whether paper, natural fabric, synthetic fabric, fabric blend, treated, untreated, etc., the print media substrates printed with the fluid sets of the present disclosure can provide acceptable optical density (OD) and/or washfastness properties. The term “washfastness” can be defined as the OD that is retained or delta E (ΔE) after five (5) standard washing machine cycles using warm water and a standard clothing detergent (e.g., Tide® available from Proctor and Gamble, Cincinnati, Ohio, USA). Essentially, by measuring OD and/or L*a*b* both before and after washing, ΔOD and ΔE value can be determined, which is essentially a quantitative way of expressing the difference between the OD and/or L*a*b* prior to and after undergoing the washing cycles. Thus, the lower the ΔOD and ΔE values, the better. In further detail, ΔE is a single number that represents the “distance” between two colors, which in accordance with the present disclosure, is the color (or black) prior to washing and the modified color (or modified black) after washing.

Colors, for example, can be expressed as CIELAB values. It is noted that color differences may not be symmetrical going in both directions (pre-washing to post washing vs. post-washing to pre-washing). Using the CIE 1976 definition, the color difference can be measured and the ΔE value calculated based on subtracting the pre-washing color values of L*, a*, and b* from the post-washing color values of L*, a*, and b*. Those values can then be squared, and then a square root of the sum can be determined to arrive at the ΔE value. The 1976 standard can be referred to herein as “ΔE_{CIE}.” The CIE definition was modified in 1994 to address some perceptual non-uniformities, retaining the L*a*b* color space, but modifying to define the L*a*b* color space with differences in lightness (L*), chroma (C*), and hue (h*) calculated from L*a*b* coordinates. Then in 2000, the CIEDE standard was established to further resolve the perceptual non-uniformities by adding five corrections, namely i) hue rotation (R_{T}) to deal with the problematic blue region at hue angles of 275°), ii) compensation for neutral colors or the primed values in the L*C*h differences, iii) compensation for lightness (S_{L}), iv) compensation for chroma (S_{C}), and v) compensation for hue (S_{H}). The 2000 modification can be referred to herein as “ΔE₂₀₀₀.” In accordance with examples of the present disclosure, ΔE value can be determined using the CIE definition established in 1976, 1994, and 2000 to demonstrate washfastness. However, in the examples of the present disclosure, ΔE_{CIE} and ΔE₂₀₀₀ are used. Further, in 1984, a difference measurement, based on a L*C*h model was defined and called CMC l:c. This metric has two parameters: lightness (l) and chroma (c), allowing users to weight the difference based on the ratio of l:c that is deemed appropriate for the application. Commonly used values include 2:1 for acceptability and 1:1 for threshold of imperceptibility. This difference metric is also reported in various examples of the present disclosure.

In further detail, the textile printing system 200 can include a fixer composition 110, which can include a quaternary amine-containing polymer and a blocked nonionic polyisocyanate in a fixer vehicle, as previously mentioned. The fixer composition can be printed from a fluidjet pen 230 which includes an ejector 232, such as a fluid ejector which can also be a thermal inkjet ejector. As mentioned, in one example, the quaternary amine-containing polymer of the fixer composition can fix the pigment of the ink composition 100 to the fabric substrate 120 and the deblocked nonionic polyisocyanates of the fixer composition can interact with the polyurethane binder of the ink composition, the fabric substrate, or both to form a covalent linkage therewith. In some examples, a curing device 240 can be used to apply heat to the fabric substrate to cure the ink composition, e.g., causing the blocked nonionic polyisocyanate to become deblocked or accelerate the deblocking process. Heat can be applied using forced hot air, a heating lamp, an oven, or the like. Heating the ink composition contacted with the fixer composition on the fabric substrate can occur at a temperature from 80° C. to 200° C. for from 5 seconds to 10 minutes, or from 130° C. to 180° C. for from 30 seconds to 4 minutes.

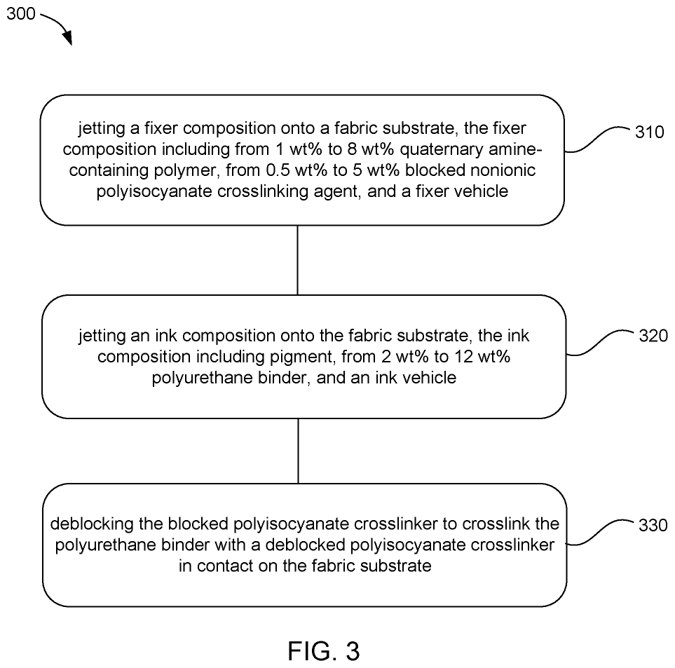

In another example, and as set forth in FIG. 3, a method 300 of textile printing can include jetting 310 a fixer composition onto a fabric substrate, the fixer composition including from 1 wt % to 10 wt % quaternary amine-containing polymer, from 0.5 wt % to 8 wt % blocked nonionic polyisocyanate crosslinking agent, and a fixer vehicle. The method can also include jetting 320 an ink composition onto the fabric substrate, the ink composition including pigment, from 2 wt % to 15 wt % polyurethane binder, and an ink vehicle. The method can further include deblocking 330 the blocked polyisocyanate crosslinker to crosslink the polyurethane binder with a deblocked polyisocyanate crosslinker in contact on the fabric substrate. In some specific examples, jetting the fixer composition onto the fabric substrate can be performed prior to jetting the ink composition onto the fabric substrate. In some examples, deblocking the blocked polyisocyanate crosslinker can occur in response to applying heat to the blocked nonionic polyisocyanate crosslinker on the fabric substrate. In some examples, this can include heating the fixer composition and the ink composition on the fabric substrate to a temperature of from 80° C. to 200° C. for a period of from 5 seconds to 10 minutes, or other suitable temperature and time-frame as disclosed herein.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those in the field technology determine based on experience and the associated description herein.

As used herein, a plurality of items, structural elements, compositional elements, and/or materials may be presented in a common list for convenience. However, these lists should be construed as though individual members of the list are individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also all the individual numerical values or sub-ranges encompassed within that range as if individual numerical values and sub-ranges are explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following are only exemplary or illustrative of the application of the principles of the presented fabric print media and associated methods. Numerous modifications and alternatives may be devised without departing from the present disclosure. The appended claims are intended to cover such modifications and arrangements. Thus, while the disclosure has been provided with particularity, the following describes further detail in connection with what are presently deemed to be the acceptable examples.

### Example 1—Preparation of Ink Compositions

Various ink compositions were prepared in accordance with the general formulations shown in Tables 1A-1B, as follows:

TABLE 1A
K, C, M, Y Ink Compositions

| | | Black (K) | Cyan (C) | Magenta (M) | Yellow (Y) |
|---|---|---|---|---|---|
| | | Ink | Ink | Ink | Ink |
| Ink ID | Category | (Wt %) | (Wt %) | (Wt %) | (Wt %) |
| Black Pigment | Pigment Dispersion | 2.5 | — | — | — |
| Cyan Pigment | Pigment Dispersion | — | 2.5 | — | — |
| Magenta Pigment | Pigment Dispersion | — | — | 3.0 | — |
| Yellow Pigment | Pigment Dispersion | — | — | — | 3.0 |
| Impranil ® DLN- | Polyurethane binder | 6 | 6 | 6 | 6 |
| SD | | | | | |
| Glycerol | Organic Cosolvent | 8 | 8 | 8 | 8 |
| LEG-1 | Organic Cosolvent | 1 | 1 | 1 | 1 |
| Crodafos ™ N3A | Surfactant | 0.5 | 0.5 | 0.5 | 0.5 |
| Surfynol ® 440 | Surfactant | 0.3 | 0.3 | 0.3 | 0.3 |
| Acticide ® B20 | Biocide | 0.044 | 0.044 | 0.044 | 0.044 |
| Deionized Water | Water | Balance | Balance | Balance | Balance |

Impranil ® is available from Covestro (USA).
Crodafos ™ is available from Croda ® International Plc. (Great Britain).
Surfynol ® is available from Evonik, (Germany).
Acticide ® is available from Thor Specialties, Inc. (USA).

TABLE 1B
White Ink Composition

| | | White (W) |
|---|---|---|
| Ink ID | Category | Ink (Wt %) |
| White Pigment | Pigment Dispersion | 10 |
| Impranil ® DLN-SD | Polyurethane binder | 8 |
| Glycerol | Organic Cosolvent | 9 |
| LEG-1 | Organic Cosolvent | 1 |
| Dowanol ™ TPM | Organic Cosolvent | 2 |
| Surfynol ® 440 | Surfactant | 0.3 |
| Acticide ® B20 | Biocide | 0.044 |
| Deionized Water | Water | Balance |

Impranil ® is available from Covestro (USA).
Dowanol ™ is available from The Dow Chemical Company (USA).
Surfynol ® is available from Evonik (Germany).
Acticide ® is available from Thor Specialties, Inc. (USA).

### Example 2—Preparation of Fixer Compositions

Various fixer compositions were prepared including fixer compositions with quaternary amine-containing polymer with and without a blocked nonionic polyisocyanate, according to Tables 2A and 2B, as follows:

TABLE 2A
Fixer Compositions

| | | Fixer-Comp | Fixer 1 | Fixer 2 |
|---|---|---|---|---|
| Component | Category | (Wt %) | (Wt %) | (Wt %) |
| LEG-1 | Organic Cosolvent | 1 | 1 | 1 |
| 2-pyrrolidone | Organic Cosolvent | 12 | 12 | 12 |
| Tetraethylene | Organic Cosolvent | — | — | — |
| Glycol | | | | |
| Surfynol ® | Surfactant | 0.3 | 0.3 | 0.3 |
| 440 | | | | |
| Floquat ™ FL- | Quaternary Amine- | 4 | 4 | 4 |
| 2350 | Containing Polymer | | | |
| Trixene ™ | Blocked Nonionic | — | 2.4 | — |
| Aqua BI 220 | Polyisocyanate | | | |
| Fixer WF-N | Blocked Nonionic | — | — | 2.4 |
| Polyisocyanate | | | | |
| Water | Solvent | Balance | Balance | Balance |

| | | | |
|---|---|---|---|
| pH | 6.2 | 6.2 | 6.4 |

TABLE 2B
Fixer Compositions (continued)

| | | Fixer 3 | Fixer 4 | Fixer 5 | Fixer 6 |
|---|---|---|---|---|---|
| Component | Category | (Wt %) | (Wt %) | (Wt %) | (Wt %) |
| LEG-1 | Organic Cosolvent | 1 | 1 | 1 | 1 |
| Surfynol ® | Surfactant | 0.3 | 0.3 | 0.3 | 0.3 |
| 440 | | | | | |
| 2-pyrrolidone | Organic Cosolvent | — | — | 12 | 12 |
| Tetraethylene | Organic Cosolvent | 12 | 12 | — | — |
| Glycol | | | | | |
| Floquat ™ FL- | Quaternary Amine- | 4 | 4 | 4 | 4 |
| 2350 | Containing Polymer | | | | |
| Trixene ™ | Blocked Nonionic | 2.4 | — | 2.4 | — |
| Aqua BI 220 | Polyisocyanate | | | | |
| Fixer WF-N | Blocked Nonionic | — | 2.4 | — | 2.4 |
| | Polyisocyanate | | | | |
| Water | Solvent | Balance | Balance | Balance | Balance |

| | | | | |
|---|---|---|---|---|
| pH | 4.0* | 4.0* | 3.9* | 4.0* |

*pH adjusted with nitric acid.
Fixer-Comp refers to a comparative fixer example without blocked nonionic polyisocyanate.
Surfynol ® is available from Evonik, (Germany).
Floquat ™ is available from SNF Ltd. (United Kingdom).
Trixene ® is available from Baxenden Chemicals Limited (United Kingdom).
Fixer WF-N is available from Matsui Shikiso Chemical (Japan).

### Example 3—Washfastness for K, C, M, and Y Inks

The K, C, M, and Y inks from Example 1 (20 grams per square meter (gsm)) were printed with or without the various fixer compositions (Fixer-Comp, Fixer 1, or Fixer 2 from Example 2 (10 gsm)). The ink compositions and fixer compositions were jetted onto gray cotton fabric print media as indicated in Table 3A below. All samples were cured at 150° C. for 3 minutes. Additionally, all printed samples were washed 5 times with Sears Kenmore 90 Series Washer (Model 110.289 227 91) and warm water (about 40° C.) with detergent and air drying between washes. The samples were measured for OD and Lab before and after the 5 washes. After the five cycles, optical density (OD) and L*a*b* values were measured for comparison, and delta E (ΔE) values were calculated using the 1976 standard denoted as ΔE_{CIE} as well as the 2000 standard denoted as ΔE₂₀₀₀. ΔE_{CMC} (2:1) values are also reported. Results are depicted in Tables 3A as follows:

TABLE 3A
Gray Cotton Fabric Substrate

| | | OD | OD | | | | |
|---|---|---|---|---|---|---|---|
| Ink | Fixer | (Pre- | (5 | % | | | ΔE_{CMC} |
| (20 gsm) | (10 gsm) | wash) | washes) | ΔOD | ΔE_{CIE} | ΔE₂₀₀₀ | (2:1) |
| K | None | 1.096 | 0.987 | −9.9 | 4.76 | 4.04 | 3.49 |
| C | None | 1.106 | 0.995 | −10.0 | 4.45 | 3.43 | 2.04 |
| M | None | 1.015 | 0.906 | −10.7 | 4.26 | 2.13 | 1.76 |
| Y | None | 1.041 | 0.922 | −11.4 | 8.01 | 1.76 | 2.52 |
| K | Fixer- | 1.209 | 1.004 | −17.0 | 8.04 | 6.64 | 6.11 |
| | Comp | | | | | | |
| C | Fixer- | 1.234 | 0.996 | −19.3 | 8.69 | 6.42 | 3.90 |
| | Comp | | | | | | |
| M | Fixer- | 1.145 | 0.986 | −13.9 | 7.08 | 3.59 | 2.76 |
| | Comp | | | | | | |
| Y | Fixer- | 1.211 | 0.993 | −18.0 | 14.24 | 2.99 | 4.33 |
| | Comp | | | | | | |
| K | Fixer 1 | 1.201 | 1.185 | −1.3 | 1.48 | 1.31 | 1.60 |
| C | Fixer 1 | 1.211 | 1.179 | −2.6 | 1.39 | 0.89 | 0.79 |
| M | Fixer 1 | 1.121 | 1.096 | −2.2 | 1.70 | 0.74 | 0.82 |
| Y | Fixer 1 | 1.200 | 1.127 | −6.0 | 2.60 | 0.56 | 0.81 |
| K | Fixer 2 | 1.201 | 1.157 | −3.7 | 1.35 | 1.19 | 1.45 |
| C | Fixer 2 | 1.204 | 1.191 | −1.1 | 1.21 | 0.66 | 0.71 |
| M | Fixer 2 | 1.131 | 1.085 | −4.0 | 2.19 | 0.99 | 0.97 |
| Y | Fixer 2 | 1.186 | 1.115 | −6.0 | 3.36 | 0.73 | 1.05 |

As can be seen in the data presented in Tables 3A, including the quaternary amine-containing polymer (Floquat™ FL-2350) improved the optical density of the printed fabric substrates, but deteriorated the washfastness. In contrast, acceptable washfastness for individual ink compositions printed in combination with fixer compositions Fixer 1 and Fixer 2 (both of which included blocked nonionic polyisocyantes) was verified by comparing pre-wash optical density (OD) with post-wash OD and ΔE_{CIE}, ΔE₂₀₀₀, or ΔE_{CMC} (2:1) calculated from pre- and post-wash L*a*b* values. This was true for black as well as all three colors (CMY). Thus, the KCMY inks of Example 1 printed with a fixer composition including both a quaternary amine-containing polymer and a blocked nonionic polyisocyanate as described in Example 2 has been shown to be a versatile fluid set and printing system. On the other hand, as also shown in Table 3A, the same inks printed without the fixer composition, or with a fixer composition excluding the blocked nonionic polyisocyanate, did not have nearly the same level of washfastness.

Additionally, the KCMY inks from Example 1 (20 gsm) with and without the Fixer 2 composition (10 gsm) were also jetted onto 100% knitted cotton, 50:50 (w/w) knitted cotton/polyester (no pre-treatment), and 50:50 (w/w) knitted cotton/polyester (with silicone-based fabric softener pre-treatment) fabric print media from Startex International. Curing, washing, etc., were as described above. Results are shown below in Tables 3B-3D:

TABLE 3B
Startex 100% Cotton Fabric Substrate

| | | OD | OD | | | | |
|---|---|---|---|---|---|---|---|
| Ink | Fixer | (Pre- | (5 | % | | | ΔE_{CMC} |
| (20 gsm) | (10 gsm) | wash) | washes) | ΔOD | ΔE_{CIE} | ΔE₂₀₀₀ | (2:1) |
| K | None | 1.183 | 0.881 | −25.5 | 13.64 | 11.65 | 9.73 |
| C | None | 1.209 | 0.918 | −24.0 | 9.55 | 7.03 | 4.26 |
| M | None | 1.094 | 0.858 | −21.6 | 15.09 | 5.86 | 5.86 |
| Y | None | 1.139 | 0.800 | −29.8 | 22.63 | 5.15 | 6.95 |
| K | Fixer 2 | 1.190 | 1.116 | −6.2 | 4.17 | 3.53 | 3.81 |
| C | Fixer 2 | 1.205 | 1.083 | −10.1 | 3.62 | 2.39 | 1.69 |
| M | Fixer 2 | 1.105 | 1.078 | −2.4 | 5.31 | 2.02 | 2.31 |
| Y | Fixer 2 | 1.181 | 1.068 | −9.6 | 12.39 | 3.49 | 3.86 |

TABLE 3C
Startex 50:50 Cotton/Polyester Fabric Substrate (no pretreatment)

| | | OD | OD | | | | |
|---|---|---|---|---|---|---|---|
| Ink | Fixer | (Pre- | (5 | % | | | ΔE_{CMC} |
| (20 gsm) | (10 gsm) | wash) | washes) | ΔOD | ΔE_{CIE} | ΔE₂₀₀₀ | (2:1) |
| K | None | 1.154 | 0.887 | −23.1 | 9.87 | 8.40 | 6.81 |
| C | None | 1.165 | 0.927 | −20.5 | 10.06 | 7.78 | 4.42 |
| M | None | 1.074 | 0.848 | −21.0 | 12.35 | 6.13 | 4.94 |
| Y | None | 1.162 | 0.869 | −25.2 | 16.26 | 3.60 | 5.03 |
| K | Fixer 2 | 1.235 | 1.104 | −10.6 | 6.57 | 5.29 | 4.83 |
| C | Fixer 2 | 1.254 | 1.078 | −14.1 | 4.47 | 3.39 | 1.99 |
| M | Fixer 2 | 1.151 | 1.008 | −12.4 | 6.27 | 2.92 | 2.67 |
| Y | Fixer 2 | 1.212 | 1.052 | −13.2 | 11.77 | 2.75 | 3.62 |

TABLE 3D
Startex 50:50 Cotton/Polyester Fabric Substrate (with pretreatment)

| | | OD | OD | | | | |
|---|---|---|---|---|---|---|---|
| Ink | Fixer | (Pre- | (5 | % | | | ΔE_{CMC} |
| (20 gsm) | (10 gsm) | wash) | washes) | ΔOD | ΔE_{CIE} | ΔE₂₀₀₀ | (2:1) |
| K | None | 1.204 | 0.878 | −27.1 | 12.81 | 10.79 | 9.07 |
| C | None | 1.232 | 0.914 | −25.9 | 10.46 | 8.13 | 4.63 |
| M | None | 1.136 | 0.855 | −24.7 | 13.79 | 6.88 | 5.54 |
| Y | None | 1.216 | 0.893 | −26.6 | 16.71 | 3.63 | 5.10 |
| K | Fixer 2 | 1.232 | 1.098 | −10.9 | 4.98 | 4.03 | 3.86 |
| C | Fixer 2 | 1.264 | 1.124 | −11.0 | 4.49 | 3.39 | 2.00 |
| M | Fixer 2 | 1.160 | 1.012 | −12.8 | 5.87 | 2.57 | 2.54 |
| Y | Fixer 2 | 1.243 | 1.101 | −11.4 | 10.54 | 2.51 | 3.24 |

As can be seen in the data presented in Tables 3B-3D, the washfastness for individual KCMY ink compositions printed in combination with fixer composition was evaluated by comparing pre-wash optical density (OD) with post-wash OD and ΔE_{CIE}, ΔE₂₀₀₀, or ΔE_{CMC} (2:1) calculated from pre- and post-wash L*a*b* values. Based on the data presented in Tables 3B-3D, it can be seen that the fixer composition improved washfastness of KCMY inks on cotton and cotton/polyester blends.

### Example 4—Washfastness for White Ink

The white ink composition from Example 1 (294.6 gsm) and Fixer-Comp and Fixer 2 from Example 2 were jetted onto knitted cotton black fabric print media. Samples were cured at 150° C. for 3 minutes. Printed samples were washed 5 times with Sears Kenmore 90 Series Washer (Model 110.289 227 91) and warm water (about 40° C.) with detergent and air drying between washes. Sample were measured for OD and Lab before and after the 5 washes. After the five cycles, ΔL*, ΔC*, and ΔE_{CIE} values were measured/calculated for comparison. Results are depicted in Tables 4A, as follows:

TABLE 4A
Gildan 100% Black Cotton Midweight (780) (knitted)

| | L* | L* | | |
|---|---|---|---|---|
| Fixer | (pre-wash) | (5 washes) | ΔL* | ΔE_{CIE} |
| None | 34.9 | — | — | — |
| Fixer-Comp | 70.4 | 63.3 | −7.1 | 7.28 |
| (9 dpp) | | | | |
| Fixer 2 (9 dpp) | 69.6 | 68.9 | −1.0 | 1.29 |

As can be seen in the data presented in Table 4A, both Fixer-Comp and Fixer 2 improved the opacity of the white ink printed on the fabric substrate. However, Fixer 2 (with blocked nonionic polyisocyanate) had improved washfastness as compared to Fixer-Comp (no blocked nonionic polyisocyanate). As presented in Table 4A, acceptable washfastness for the white ink composition printed in combination with Fixer 2 was verified by comparing pre-wash L* with post-wash L* and ΔL* and ΔE_{CIE} calculated from pre- and post-wash L*a*b* values. Thus, the white ink of Example 1 printed with fixer compositions including both quaternary amine-containing polymer and blocked nonionic polyisocyanate as described in Example 2 have been shown to be a versatile fluid set and printing system.

While the present technology has been described with reference to certain examples, various modifications, changes, omissions, and substitutions can be made without departing from the spirit of the disclosure. It is intended, therefore, that the disclosure be limited only by the scope of the following claims.

What is claimed is:

1. A fluid set, comprising:
an ink composition including:
an ink vehicle,
pigment, and
from 2 wt % to 15 wt % polyurethane binder; and
a fixer composition including:
a fixer vehicle,
from 1 wt % to 10 wt % quaternary amine-containing polymer, and
from 0.5 wt % to 8 wt % blocked nonionic polyisocyanate crosslinking agent.

2. The fluid set of claim 1, wherein the quaternary amine-containing polymer has a weight average molecular weight of from 3,000 Mw to 200,000 Mw.

3. The fluid set of claim 1, wherein the quaternary amine-containing polymer includes a dimethylamine-epichlorohydrin copolymer having the structure: 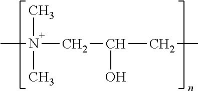
where n is from 22 to 1,500.

4. The fluid set of claim 1, wherein the quaternary amine-containing polymer includes polydiallyldimethylammonium chloride (polyDADMAC) having the structure: 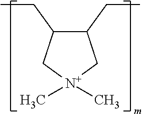
where m is from 18 to 1,250.

5. The fluid set of claim 1, wherein the blocked nonionic polyisocyanate crosslinker includes a blocked nonionic isocyanate trimer having the structure:
(NCO)₃R₃(NHCO)₃(BL)_{3-X}(DL)_{X}
where individual R groups independently includes a C2 to C10 branched or straight-chained alkyl, C6 to C20 alicyclic, C6 to C20 aromatic, or a combination thereof; BL includes a phenol blocking group, a lactam blocking group, an oxime blocking group, a pyrazole blocking group, or a combination thereof; x is from 0 to 1; and DL includes a hydrophilic dispersing group.

6. The fluid set of claim 1, wherein the pigment is a white pigment selected from titanium dioxide, talc, zinc oxide, zinc sulfide, lithopone, or a combination thereof.

7. The fluid set of claim 1, wherein the fixer vehicle comprises water and an organic co-solvent, the water being present in the fixer composition in an amount of from 60 wt % to 95 wt %, and the organic co-solvent being present in the fixer composition in an amount of from 1.5 wt % to 38.5 wt %.

8. A textile printing system, comprising:
a fabric substrate;
an ink composition including:
an ink vehicle,
pigment, and
from 2 wt % to 15 wt % polyurethane binder; and
a fixer composition including:
a fixer vehicle,
from 1 wt % to 10 wt % quaternary amine-containing polymer, and
from 0.5 wt % to 8 wt % blocked nonionic polyisocyanate crosslinking agent.

9. The textile printing system of claim 8, wherein the fabric substrate includes cotton, polyester, nylon, silk, or a blend thereof.

10. The textile printing system of claim 8, wherein the blocked nonionic polyisocyanate crosslinker includes a blocked nonionic isocyanate trimer.

11. The textile printing system of claim 8, wherein the quaternary amine-containing polymer includes a dimethylamine-epichlorohydrin copolymer having the structure: 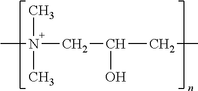
where n is from 22 to 1,500, or polydiallyldimethylammonium chloride (polyDADMAC) having the structure: 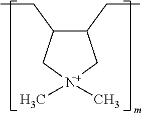
where m is from 18 to 1,250, or a combination thereof.

12. A method of textile printing, comprising:
jetting a fixer composition onto a fabric substrate, the fixer composition comprising from 1 wt % to 10 wt % quaternary amine-containing polymer, from 0.5 wt % to 8 wt % blocked nonionic polyisocyanate crosslinking agent, and a fixer vehicle;
jetting an ink composition onto the fabric substrate, the ink composition comprising pigment, from 2 wt % to 12 wt % polyurethane binder, and an ink vehicle; and
deblocking the blocked polyisocyanate crosslinker to crosslink the polyurethane binder with a deblocked polyisocyanate crosslinker in contact on the fabric substrate.

13. The method of textile printing of claim 12, wherein jetting the fixer composition is performed prior to jetting the ink composition.

14. The method of textile printing of claim 12, wherein deblocking the blocked polyisocyanate crosslinker occurs in response to applying heat to the blocked nonionic polyisocyanate crosslinker on the fabric substrate.

15. The method of textile printing of claim 14, wherein applying heat is at a temperature of from 120° C. to 200° C. for a period of from 5 seconds to 10 minutes.
